(19) United States
(12) Patent Application Publication
(10) Pub. No.: US 2021/0387422 A1
(43) Pub. Date: Dec. 16, 2021

(54) SUPPORT MATERIALS FOR THREE-DIMENSIONAL PRINTING

(71) Applicant: HERCULES LLC, Wilmington, DE (US)

(72) Inventor: Zhendong LIU, Warrington, PA (US)

(73) Assignee: HERCULES LLC, Wilmington, DE (US)

(21) Appl. No.: 17/282,949

(22) PCT Filed: Oct. 7, 2019
(86) PCT No.: PCT/US2019/054961

§ 371 Date: Apr. 5, 2021

Related U.S. Application Data
(60) Provisional application No. 62/742,198, filed on Oct. 5, 2018.

(51) Int. Cl. B29C 64/40; C08L 1/28; C08L 39/06

(52) U.S. Cl. CPC B29C 64/40; B33Y 10/00; C08L 39/06; C08L 1/284

(57) ABSTRACT

The present disclosure relates generally to a support material for three-dimensional printing comprising a blend of at least two cellulose ethers or a blend of at least one cellulose ether and at least one vinyl pyrrolidone polymer. Additionally, the present disclosure relates to a shaped material and a three-dimensionally printed object comprising the support material. Furthermore, a process for producing a three-dimensional object using the support material is also disclosed.

### FIELD OF THE INVENTION

The presently disclosed process(es), procedure(s), method(s), product(s), result(s), and/or concept(s) (collectively referred to hereinafter as the “present disclosure”) relates generally to a support material for three-dimensional printing comprising a blend of at least two cellulose ethers or a blend of at least one cellulose ether and at least one vinyl pyrrolidone polymer. Additionally, the present disclosure relates to a shaped material and a three-dimensionally printed object comprising the support material. Furthermore, a process for producing a three-dimensional object using the support material is also disclosed.

### BACKGROUND OF THE INVENTION

Three-dimensional (3D) printing is a type of additive manufacturing where the shapes of printed objects are modeled incrementally, layer by layer. In particular, 3D printing is a process of making a 3D solid object from a digital model, where successive layers of material are laid down (i.e., by a 3D printer) in different shapes. After one layer is printed, the next layer is placed on top of it.

There are various 3D printing technologies. More economical 3D printing is a fused filament fabrication process (FFF) also known as fused deposit modeling (FDM). In a typical fused filament fabrication process, a three-dimensional object is produced by extruding a thermoplastic material through a nozzle to form layers as the thermoplastic material hardens after extrusion. A plastic filament is unwound from a coil and supplies thermoplastic material to the extrusion nozzle which can be turned on or off to control the flow. The nozzle is heated to heat the thermoplastic material past its melting and/or glass transition temperature and is then deposited by the extrusion head on a base to form a three-dimensional object in a layer-wise fashion. The thermoplastic material is typically selected, and its temperature is controlled so that it solidifies substantially immediately upon extrusion or dispensing onto the base, with the buildup of multiple layers to form the desired three-dimensional object. The thermoplastic material is commonly known as a build material or a modeling material. Generally, the thermoplastic materials are thermoplastic polymers such as polyethylene, polypropylene, acrylonitrile-butadiene-styrene (ABS) copolymers, polycarbonates, polyamides, and polylactic acids.

However, this approach can lead to problems when printing objects with overhangs or geometry that is not directly connected to the ground, a printing platform or pad, or other supportive surfaces. This is because, in such cases, material is printed in empty space without any support from previous layers. For a 3D object with overhangs or other floating features not connected to the ground, there are not underlying layers of the objects to support the overhangs. One solution to overcome this problem is to print supporting material below the problematic, overhanging features. Such supporting material can hold the overhangs and be removed after the printing is finished. For some existing 3D printing technologies, the supporting material can be dissolved or washed away from the solid 3D object after printing is completed. So, the supporting material functions as a sacrificial material for the solid 3D object.

Currently, known supporting materials have not satisfied the requirements for 3D printing technologies. For example, polyvinyl alcohol (PVA) is used widely as a support material for a build material like ABS. PVA and ABS can be printed simultaneously. After the 3D printing has been completed, the printed object can be submerged in water. The PVA is dissolved in warm water and leaves the ABS portion of the printed article intact. Unfortunately, PVA is quite difficult to print and does not sufficiently adhere to ABS. In addition, PVA is highly sensitive to moisture and dissolved only in warm water. Other known supporting materials cannot be used in FFF unless a substantial amount of additives such as plasticizers is used. In view of the deficiencies of the known support materials in three-dimensional printing, it is desirable to provide other support materials for three-dimensionally printed objects, which can have lower moisture sensitivity, higher dissolution at room temperature and better adhesion to the build material, thus better printability without a substantial amount of the additives.

### SUMMARY OF THE INVENTION

One aspect of the present disclosure provides a support material for three-dimensional printing comprising a blend of at least one cellulose ether and at least one vinyl pyrrolidone polymer.

Another aspect of the present disclosure provides a support material for three-dimensional printing comprising a blend of at least two cellulose ethers.

In one embodiment of the present disclosure, the cellulose ether is selected from the group consisting of hydroxypropyl cellulose, hydroxypropyl methyl cellulose, hydroxyethyl methyl cellulose, ethyl cellulose, hydroxyethyl cellulose, carboxymethyl hydroxyethyl cellulose and combinations thereof. In one embodiment, the cellulose ether is hydroxypropyl cellulose or ethyl cellulose.

In one embodiment, the cellulose ether is hydroxypropyl cellulose having a weight average molecular weight in the range of from 2,000 to about 2,000,000 Daltons. In another embodiment, the weight average molecular weight of the hydroxypropyl cellulose is from about 3,000 to about 1,000,000 Daltons. In another embodiment, the weight average molecular weight of the hydroxypropyl cellulose is from about 5,000 to about 500,000 Daltons. In one embodiment, the molar substitution of the hydroxypropyl cellulose is from 2.0 to 5.0. In another embodiment, the molar substitution of the hydroxypropyl cellulose is from 2.5 to 4.6. In another embodiment, the molar substitution of the hydroxypropyl cellulose is from 3.0 to 4.4.

In another embodiment, the cellulose ether is ethyl cellulose having ethoxy contents in the range of from 35 wt. % to 60 wt. %.

In one embodiment of the present disclosure, the vinyl pyrrolidone polymer is selected from the group consisting of a polyvinyl pyrrolidone (PVP), an alkylated polyvinyl pyrrolidone, a vinyl pyrrolidone/vinyl acetate (VP/VA) copolymer, a vinyl pyrrolidone/dimethylaminoethylmethacrylate (VP/DMAEMA) copolymer, a vinyl pyrrolidone/dimethylaminopropylmethacrylamide (VP/DMAPA) copolymer, a vinyl pyrrolidone/methacrylamidopropyl trimethylammonium chloride copolymer, a vinyl pyrrolidone/dimethylaminopropylmethacrylamide/methacrylamidopropyl trimethylammonium chloride terpolymer, a vinyl pyrrolidone/acrylic acid/lauryl methacrylate terpolymer, a vinyl pyrrolidone/acrylic acid copolymer, a vinyl pyrrolidone/vinyl caprolactam copolymer, a vinyl pyrrolidone/vinyl caprolactam/dimethylaminoethylmethacrylate terpolymer, a vinyl pyrrolidone/vinyl caprolactam/dimethylaminopropylmethacrylamide terpolymer, a vinyl pyrrolidone/vinyl caprolactam/dimethylaminopropylmethacrylamide/methacryloylaminopropyl lauryl dimethylammonium chloride tetrapolymer, and a vinyl pyrrolidone/styrene copolymer. In one embodiment, the weight average molecular weight of the vinyl pyrrolidone polymer is from about 1,000 to about 3,000,000 Daltons. In another embodiment, the weight average molecular weight of the vinyl pyrrolidone polymer is from about 2,000 to about 1,000,000 Daltons. In another embodiment, the weight average molecular weight of the vinyl pyrrolidone polymer is from about 3,000 to about 200,000 Daltons.

In one embodiment of the present disclosure, the ratio of the cellulose ether to the vinyl pyrrolidone polymer is from about 95:5 to about 5:95 by weight. In another embodiment, the ratio is from about 95:5 to about 25:75 by weight. In still another embodiment, the ratio is from about 90:10 to about 50:50 by weight.

In one embodiment of the present disclosure, the support material is present in a solid state of powder or granulate.

Another aspect of the present disclosure provides a shaped material comprising the support material of the present disclosure. In one embodiment of the present disclosure, the shaped material has a shape of a pellet, a rod, or a filament.

Another aspect of the present disclosure provides a three-dimensionally printed object comprising a build material and the support material of the present disclosure. In one embodiment of the present disclosure, the build material is selected from the group consisting of acrylonitrile butadiene styrene (ABS) copolymers, polylactic acid (PLA), polyamides, polyethylene, polypropylene, polycarbonates, polyoxymethylene (POM), ethylene vinyl acetate copolymers, polyphenylene ether, acrylonitrile styrene acrylate (ASA) copolymers, polyethylene terephthalate (PET), PETG (PET with a glycol modification), high impact polystyrene (HIPS), polyether ether ketone (PEEK), thermoplastic polyurethane, polyetherimide, and combinations thereof.

Another aspect of the present disclosure provides a use of the support material of the present disclosure in three-dimensional printing. In one embodiment of the present disclosure, the support material is used for supporting at least one layer of a build material. In one embodiment of the present disclosure, the build material is selected from the group consisting of acrylonitrile butadiene styrene (ABS) copolymers, polylactic acid (PLA), polyamides, polyethylene, polypropylene, polycarbonates, polyoxymethylene (POM), ethylene vinyl acetate copolymers, polyphenylene ether, acrylonitrile styrene acrylate (ASA) copolymers, polyethylene terephthalate (PET), PETG (PET with a glycol modification), high impact polystyrene (HIPS), polyether ether ketone (PEEK), thermoplastic polyurethane, polyetherimide, and combinations thereof.

In one embodiment of the present disclosure, the three-dimensional printing comprises a fused deposition modeling.

Another aspect of the present disclosure provides a process for producing a three-dimensional object wherein the process comprising the steps of:

(i) depositing the support material of the present disclosure into a build chamber with a layer-based additive technique to form a support structure;

(ii) depositing a build material into the build chamber with the layer-based additive technique to form the three-dimensional object, wherein the three-dimensional object comprises at least one region supported by the support structure; and

(iii) removing the support structure from the three-dimensional object with a liquid medium.

In one embodiment of the present disclosure, the build material is selected from the group consisting of acrylonitrile butadiene styrene (ABS) copolymers, polylactic acid (PLA), polyamides, polyethylene, polypropylene, polycarbonates, polyoxymethylene (POM), ethylene vinyl acetate copolymers, polyphenylene ether, acrylonitrile styrene acrylate (ASA) copolymers, polyethylene terephthalate (PET), PETG (PET with a glycol modification), high impact polystyrene (HIPS), polyether ether ketone (PEEK), thermoplastic polyurethane, polyetherimide, and combinations thereof.

In one embodiment of the present disclosure, the liquid medium comprises water, an aqueous solution and a solvent. In another embodiment, the liquid medium is the aqueous solution having a pH of about 5.0 to about 9.0.

### DETAILED DESCRIPTION OF THE INVENTION

Before explaining at least one embodiment of the present disclosure in detail, it is to be understood that the present disclosure is not limited in its application to the details of construction and the arrangement of the components or steps or methodologies set forth in the following description. The present disclosure is capable of other embodiments or of being practiced or carried out in many ways. Also, it is to be understood that the phraseology and terminology employed herein is for the purpose of description and should not be regarded as limiting.

Unless otherwise defined herein, technical terms used in connection with the present disclosure shall have the meanings that are commonly understood by those of ordinary skill in the art. Further, unless otherwise required by context, singular terms shall include pluralities and plural terms shall include the singular.

All patents, published patent applications, and non-patent publications mentioned in the specification are indicative of the level of skill of those skilled in the art to which the present disclosure pertains. All patents, published patent applications, and non-patent publications referenced in any portion of this application are herein expressly incorporated by reference in their entirety to the same extent as if each individual patent or publication was specifically and individually indicated to be incorporated by reference.

All of the articles and/or methods disclosed herein can be made and executed without undue experimentation in light of the present disclosure. While the articles and methods of the present disclosure have been described in terms of preferred embodiments, it will be apparent to those of ordinary skill in the art that variations may be applied to the articles and/or methods and in the steps or in the sequence of steps of the method(s) described herein without departing from the concept, spirit and scope of the present disclosure. All such similar substitutes and modifications apparent to those skilled in the art are deemed to be within the spirit, scope and concept of the present disclosure.

As utilized in accordance with the present disclosure, the following terms, unless otherwise indicated, shall be understood to have the following meanings.

The use of the word “a” or “an” when used in conjunction with the term “comprising” may mean “one,” but it is also consistent with the meaning of “one or more,” “at least one,” and “one or more than one.” The use of the term “or” is used to mean “and/or” unless explicitly indicated to refer to alternatives only if the alternatives are mutually exclusive, although the disclosure supports a definition that refers to only alternatives and “and/or.” Throughout this application, the term “about” is used to indicate that a value includes the inherent variation of error for the quantifying device, the method(s) being employed to determine the value, or the variation that exists among the study subjects. For example, but not by way of limitation, when the term “about” is utilized, the designated value may vary by plus or minus twelve percent, or eleven percent, or ten percent, or nine percent, or eight percent, or seven percent, or six percent, or five percent, or four percent, or three percent, or two percent, or one percent. The use of the term “at least one” will be understood to include one as well as any quantity more than one, including but not limited to, 1, 2, 3, 4, 5, 10, 15, 20, 30, 40, 50, 100, etc. The term “at least one” or “at least two” may extend up to 100 or 1000 or more depending on the term to which it is attached. In addition, the quantities of 100/1000 are not to be considered limiting as lower or higher limits may also produce satisfactory results. In addition, the use of the term “at least one of X, Y, and Z” will be understood to include X alone, Y alone, and Z alone, as well as any combination of X, Y, and Z. The use of ordinal number terminology (i.e., “first”, “second”, “third”, “fourth”, etc.) is solely for the purpose of differentiating between two or more items and, unless otherwise stated, is not meant to imply any sequence or order or importance to one item over another or any order of addition.

As used herein, the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps. The terms “or combinations thereof” and “and/or combinations thereof” as used herein refer to all permutations and combinations of the listed items preceding the term. For example, “A, B, C, or combinations thereof” is intended to include at least one of: A, B, C, AB, AC, BC, or ABC and, if order is important in a particular context, also BA, CA, CB, CBA, BCA, ACB, BAC, or CAB.

Continuing with this example, expressly included are combinations that contain repeats of one or more items or terms, such as BB, AAA, AAB, BBC, AAABCCCC, CBBAAA, CABABB, and so forth. The skilled artisan will understand that typically there is no limit on the number of items or terms in any combination, unless otherwise apparent from the context.

For purposes of the following detailed description, other than in any operating examples, or where otherwise indicated, numbers that express, for example, quantities of ingredients used in the specification and claims are to be understood as being modified in all instances by the term “about”. The numerical parameters set forth in the specification and attached claims are approximations that may vary depending upon the desired properties to be obtained in carrying out the invention.

The term “support material” according to the present disclosure describes the material which forms a support structure for overhangs or narrow cavities and the like of the three-dimensional object made from the modeling material during the FFF process.

The term “build material” or “modeling material” according to the present disclosure describes the material out of which the three-dimensional object itself is manufactured by the FFF process.

All percentages, ratio, and proportions used herein are based on a weight basis unless other specified.

The present disclosure is directed to a support material for three-dimensional printing. In one perspective, the support materials can be a blend comprising at least two cellulose ethers. In another perspective, the support materials can be a blend comprising at least one cellulose ether and at least one vinyl pyrrolidone polymer. The cellulose ether can include, but are not limited to, hydroxypropyl cellulose, hydroxypropyl methyl cellulose, carboxymethyl cellulose, hydroxyethyl methyl cellulose, methyl cellulose, ethyl cellulose, hydroxyethyl cellulose, carboxymethyl hydroxyethyl cellulose and their combinations.

The cellulose ether can have weight average molecular weights in a range of from about 2,000 to about 2,500,000 Daltons, or from about 3,000 to about 2,000,000 Daltons, or from about 4,000 to about 1000,000 Daltons, or from about 5,000 to about 500,000 Daltons.

In one non-limiting embodiment, the cellulose ether can be hydroxypropyl cellulose. A molar substitution of the hydroxypropyl cellulose can be from about 2.0 to about 5.0, or from about 2.5 to about 4.6, or from about 3.0 to about 4.4.

In another non-limiting embodiment, the cellulose ether can be ethyl cellulose (EC). The ethoxy contents of the ethyl cellulose can be from about 35% to about 60%, or from about 40% to about 55%, or from about 45% to about 55%.

The vinyl pyrrolidone polymer used in the present disclosure can be a homopolymer, a copolymer, a terpolymer and/or a tetrapolymer of vinyl pyrrolidone. Examples of the vinyl pyrrolidone polymer can include, but are not limited to, a polyvinyl pyrrolidone (PVP), an alkylated polyvinyl pyrrolidone, a vinyl pyrrolidone/vinyl acetate (VP/VA) copolymer, a vinyl pyrrolidone/dimethylaminoethylmethacrylate (VP/DMAEMA) copolymer, a vinyl pyrrolidone/dimethylaminopropylmethacrylamide (VP/DMAPA) copolymer, a vinyl pyrrolidone/methacrylamidopropyl trimethylammonium chloride copolymer, a vinyl pyrrolidone/dimethylaminopropylmethacrylamide/methacrylamidopropyl trimethylammonium chloride terpolymer, a vinyl pyrrolidone/acrylic acid/lauryl methacrylate terpolymer, a vinyl pyrrolidone/acrylic acid copolymer, a vinyl pyrrolidone/vinyl caprolactam copolymer, a vinyl pyrrolidone/vinyl caprolactam/dimethylaminoethylmethacrylate terpolymer, a vinyl pyrrolidone/vinyl caprolactam/dimethylaminopropylmethacrylamide terpolymer, a vinyl pyrrolidone/vinyl caprolactam/dimethylaminopropylmethacrylamide/methacryloylaminopropyl lauryl dimethylammonium chloride tetrapolymer, and a vinyl pyrrolidone/styrene copolymer, and their combinations.

In one embodiment of the present disclosure, the vinyl pyrrolidone polymer is alkylated polyvinyl pyrrolidone.

The alkylated polyvinyl pyrrolidone can be prepared by homopolymerization of N-vinylpyrrolidone or a lower alkyl substituted N-vinylpyrrolidone and subsequent alkylation with an alpha-olefin of at least 2 carbon atoms, or from about 4 to about 30 carbon atoms. Also, these polymers can be prepared by copolymerization of N-vinylpyrrolidone with an alpha-olefin of at least 2 carbon atoms or from about 4 to about 30 carbon atoms.

The vinyl pyrrolidone polymers can have weight average molecular weights in a range of from about 1,000 to about 3,000,000 Daltons, or from about 2,000 to about 1,000,000 Daltons, or from about 3,000 to about 200,000 Daltons.

In a blend comprising at least one cellulose ether and at least one vinyl pyrrolidone polymer, a ratio of the cellulose ether to the vinyl pyrrolidone polymer can be from about 95:5 to about 5:95 by weight, or from about 95:5 to about 25:75 by weight, or from about 90:10 to about 50:50 by weight.

In a blend comprising two cellulose ether, a ratio of the two cellulose ethers can be from about 99:1 to about 1:99 by weight, or from about 95:5 to about 25:75 by weight, or from about 92.5:7.5 to about 50:50 by weight.

The support material may further comprise additives, different from the above-mentioned blend, such as rheological modifiers, stabilizers, lubricants, fillers, plasticizers, pigments and/or impact modifiers. However, an advantage of the present disclosure is that the presence of such additives different from the above-mentioned blend is optional. Another advantage of the support material in the present disclosure is that it can be dissolved at room temperature or even low temperatures. Thus, no heat is needed for the dissolution of the support material.

Non-limiting examples of the fillers can include carbohydrates, sugars, sugar alcohols, proteins, inorganic salts/ceramics, graphene, graphite, carbon nanotube/fibers, glass fibers, metals and alloys. Inorganic salts/ceramics can include, but are not limited to, oxides, carbides, nitrides, silicates, aluminum silicates, titanates, clay, mica, calcium carbonate, aluminum magnesium silicates, phosphates, chlorides, nitrates, borates, borides, sulfites, sulfides and sulfates. Metals and alloys can include, but are not limited to, iron, steel, nickel, cobalt, aluminum, titanium, copper, silver, gold and their alloys.

Examples of the lubricants can include, but are not limited to, polyethylene oxide homopolymers, copolymers and terpolymers; glycols; or oil lubricants, such as light mineral oil, corn oil; high molecular weight polybutenes; polyol esters; a blend of light mineral oil and wax emulsion; a blend of paraffin wax in corn oil; hydrocarbon waxes; metal fatty acid salts such as magnesium stearate and calcium stearate; polytetrafluoroethylene; graphite and combinations thereof. Typically, the amounts of the lubricants can be from about 0.1 to about 20 percent, or from about 0.3 to about 10 percent, based on the total weight of the blend.

Stabilizers are mainly antioxidants and UV absorbers, including ascorbic acid, N, N′-di-2-butyl-1,4-phenylenediamine, butylated hydroxytoluene, di-tert-butylphenol, dimethyl-6-tert-butylphenol, oxanilides, benzophenones, benzotriazoles and hydroxyphenyltriazines.

Plasticizer includes phosphates; phthalates such as dibutyl phthalate, dicyclohexyl phthalate, benzyl phthalate; and diphenyl phthalate; adipates; sebacates such as dibutyl sebacate; maleates; citrates such as triethyl citrate; polyethylene glycols; benzoates; organophosphates such as cresyl diphenyl phosphate; sulfonamides; stearates such as butyl stearate; sorbitol; sobitan monolaurates; sorbitan monopalmitates; sorbitan monostearates; sorbitan monooleates; glycerides; esters of higher fatty acids and amides; glycol esters of coconut oil fatty acids; acetylated monoglyceride; glycerine; castor oil; butyl phthalyl butyl glycolate; butyl ricinoleate; triacetin and combinations.

Pigments includes inorganic pigments and organic pigments. Inorganic pigments include carbon, clay or metal pigments based on cadmium, chromium, cobalt, copper, iron, lead, manganese, mercury, titanium, zinc or aluminum. Common organic pigments include azo pigments, lake pigments, phthalocyanine pigments and quinacridone pigments. Some examples are pigment yellow 3, 6, 14, 17, 65; pigment red 12, 122, 4, 13; pigment blue 1, pigment violet 3, pigment orange 5 etc.

Uniform mixing of the blends with one or more optional additives, e.g., selected from fillers, lubricants, stabilizers and antioxidants to produce the support material can be accomplished by, for example, a known conventional kneading process. The blends used as support materials in the present disclosure can be provided in a shaped material in a form of a filament, pellet or rod.

The support materials of the present disclosure can be removed by immersing, spraying with or contacting with a liquid medium including water, an aqueous solution and/or a solvent depending on the specific blend. The temperature of the liquid medium can be normally varied in a range of about 0 to about 100° C., or about 2 to about 40° C., or about 4 to about 36° C.

The water can be any types of water including tap water, deionized water and distilled water. As used herein, the term “solution, includes full solutions in which the solutes are fully dissolved in water or aqueous solvent, and partial solutions in which the solutes are at least partially dissolved in water or the aqueous solvent. Suitable solutes can be water-soluble inorganic salts, for example, an alkali metal salt and an alkaline earth metal salt. The alkali metal salt is for example an alkali metal halide selected from sodium chloride, potassium chloride, sodium iodide and sodium bromide. The alkaline earth metal salt is for example an alkaline earth metal halide selected from calcium chloride and magnesium chloride. These inorganic salts can be used in the form of a mixture of two or more thereof. The aqueous solution can have a pH value in a range of about 6 to about 9, or about 6 to about 8. The aqueous solutions may also be agitated and/or subjected to ultrasonic frequencies.

In one non-limiting embodiment, the solvents can be water-miscible organic solvents or non-polar organic solvents. Examples can include, but are not limited to, low molecular weight alcohols such as ethanol, methanol, isopropanol, propanol and butanol; ketones such as acetone, methyl ethyl ketone, methyl propyl ketone and isopropyl methyl ketone; alkyl acetates such as methyl acetate and ethyl acetate; pyrrolidines such as 2-pyrolidone, N-methyl-2-pyrrolidone, N-ethyl-2-pyrrolidone and N-hydroxyethyl-2-pyrrolidone; hexane; heptane; cyclohexane; kerosene; mineral spirits; tetrahydrofuran; toluene; xylene; mineral oil; linseed oil; limonene; chloroform; methylene chloride; glycols such as ethylene glycol, propylene glycol, diethylene glycol, triethylene glycol and glycerin; glycol ethers such as diethylene glycol ethyl ether, diethylene glycol monobutyl ether, diethylene glycol butyl ether acetate, ethylene glycol butyl ether, ethylene glycol ethyl ether, ethylene glycol ethyl ether acetate, dipropylene glycol methyl ether, dipropylene glycol n-butyl ether, propylene glycol n-butyl ether, propylene glycol phenyl ether and propylene glycol methyl ether acetate. In another non-limiting embodiment, the solvent can be limonene.

The blend used as a support material according to the present disclosure shows significantly shorter times for solubilization, better adhesion to a build material and better printability in a 3D printer compared to support materials known in the state of the art. In addition, the blend can be easily removed from a three-dimensional object printed from the 3D printer. Furthermore, elevated temperatures are not needed to dissolve the support material in a liquid medium.

The build material used in the present disclosure can be any thermoplastic materials comprising a thermoplastic polymer. Accordingly, any thermoplastic material capable of being extruded may be used. Suitable build materials can include, but are not limited to, polyolefins like polyethylene or polypropylene, acrylonitrile-butadiene-styrene (ABS) copolymers, polycarbonates, polyamides, polylactic acids and blends of the aforementioned polymers.

The build materials used in the present disclosure can also include, but are not limited to, acrylonitrile butadiene styrene (ABS) copolymers, polyoxymethylene, polylactic acid (PLA), ethylene vinyl acetate copolymers, polyphenylene ether, ethylene-acrylic acid copolymer, polyether block amide, polybutylene terephthalate, polyethylene terephthalate (PET), polycyclohexylenedimethylene terephthate, polyphenylene sulfide, polyphthalamide (PPA), polymethylmethacrylate, polysulfones, polyphenylsulfones, polyacrylonitrile, polystyrene, polyolefins including polyethylene and polypropylene, polyvinyl butyral, polyvinyl chlorides, polyurethanes, polyamides, polycarbonates, polyoxymethylene (POM), ethylene vinyl acetate copolymers, polyphenylene ether, acrylonitrile styrene acrylate (ASA) copolymers, PETG (PET with a glycol modification), high impact polystyrene (HIPS), polyether ether ketone (PEEK), thermoplastic polyurethane, polyetherimide, and combinations thereof.

The “layer-based additive technique” for the purpose of the present disclosure is a technique, wherein a first layer of material is deposited on a base in a build chamber to form a first layer of material, followed by the deposition of a second layer of material on the first layer of material, followed by the deposition of a third layer of material and so on. The number of layers deposited by the layer-base additive technique depends on the size of the three-dimensional object and the support structure respectively. Moreover, the number of layers depends on the thickness of the layers deposited.

An FFF-process (fused filament fabrication process) in the present disclosure is a process in which at least one build material and at least one support material are each initially present in a solid state and thereafter melted and printed to form a three-dimensional object comprising the modeling material, which is supported by the support material. Subsequently the support material is removed by dissolving to obtain the three-dimensional object itself.

The present disclosure also relates to a process for producing a three-dimensional object which comprises: (i) depositing a support material comprising the above-described blend into a build chamber with a layer-based additive technique to form a support structure, optionally on a substrate; (ii) depositing a build material as described above into the build chamber with the layer-based additive technique to form the three-dimensional object comprising at least one region supported by the support structure; and (iii) removing the support structure from the three-dimensional object with a liquid medium.

Suitable substrates on which the three-dimensional object is formed are known in the art, such as plates or sheets made of glass, metal or synthetic materials.

In one non-limiting embodiment, the process can be carried out according to fused deposition modeling (FDM). At least one build material and at least on support material are each initially present in a solid state and thereafter melted in nozzles and printed to form a three-dimensional object comprising the build material, which is supported by the support material. Subsequently the support material is removed by dissolving in a liquid medium to obtain the three-dimensional object itself. The build material and the support material can be heated to the same or different temperatures to bring them into a molten or softened shape.

Dissolution of the support material can be carried in a way known in the art. In one non-limiting embodiment, the three-dimensional object comprising the build material and the support material can be brought in contact with the liquid medium. In another non-limiting embodiment, the three-dimensional object comprising the build material and the support material therefore can simply be placed in a bath comprising the liquid medium.

The following examples illustrate the present disclosure, parts and percentages being by weight, unless otherwise indicated. Each example is provided by way of explanation of the present disclosure, not limitation of the present disclosure. In fact, it will be apparent to those skilled in the art that various modifications and variations can be made in the present disclosure without departing from the scope or spirit of the invention. For instance, features illustrated or described as part of one embodiment, can be used on another embodiment to yield a still further embodiment. Thus, it is intended that the present disclosure covers such modifications and variations as come within the scope of the appended claims and their equivalents.

### Examples

### Support Filament Preparation

Experimental filaments with diameter of 1.7-2 mm were made on a Leistritz-18 mm twin screw co-rotating hot melt extruder (HME) equipped with a 2 mm die (commercially available from Leistritz Extrusion Technologies Corp., Germany). The HME process parameters are listed in Table 1. The experimental filaments were made using HPC, HPC and additives, blends of HPC and EC, and blends of HPC and VP polymer. However, the experimental filaments of VP polymers alone were very brittle and easily broken. Such filaments could not be used as support materials for printing.

TABLE 1
HME Processing Parameters

| | | | | | | | | Process Condition | | |
|---|---|---|---|---|---|---|---|---|---|---|
| | | | | | | | | Powder | Cooling | Melt |
| Temperature, ° C. | | | | | | | | Feed Rate, | belt speed, | Pressure |
| Zone1 | Zone2 | Zone3 | Zone4 | Zone5 | Zone6 | Zone7 | Zone8 | kg/hour | cm/sec | (PSI) |
| 40 | 60 | 120 | 150 | 160 | 160 | 160 | 160 | 1 | 15 | 230 |

### Moisture Sensitivity Measurement

The filament samples were cut to about 2″ in length, then were dried in an 80° C. oven for 2 hours, before being allowed to sit on a bench in air at about 20 to 25° C. for about one week to absorb moisture. Then the filament samples were weighed and put back into the 80° C. oven. The samples were then weighed at 4 and 18 days. The data is listed in Table 2. The weight ratio is Component 1 to Component 2.

### Aqueous Dissolution Measurement

The filaments were cut into about ½″. 0.6 g of such filaments were added into a beaker containing 200 g tap water at 20-25° C. The filaments were dissolved without stirring. The dissolution times were recorded and shown in Table 2.

TABLE 2
Moisture and Dissolution Time Measurement

| | Ingredients | | | Moisture Loss, wt % | | |
|---|---|---|---|---|---|---|
| | | | Weight | 4 | 18 | Dissolution |
| Sample | Component 1 | Component 2 | Ratio | Days | Days | Time (Min) |
| 1 | Klucel ™ E | — | — | 6.75 | 6.79 | 250 |
| 2 | Klucel ™ E | PVP K12 | 90/10 | 8.55 | 8.73 | 210 |
| 3 | Klucel ™ E | Ganex ™ P-904LC | 75/25 | 7.96 | 8.11 | 250 |
| 4 | Klucel ™ E | PVP/VA S-630 | 75/25 | 7.74 | 8.14 | 180 |
| 5 | Klucel ™ E | Stearate | 90/10 | 6.12 | 6.34 | 600 |
| 6 | Klucel ™ E | Aqualon ™ EC N4 | 90/10 | 7.56 | 7.56 | 180 |
| 7 | Klucel ™ E | Aqualon ™ EC N4 | 70/30 | 7.80 | 7.61 | 460 |

Klucel ™ E: Hydroxypropyl cellulose, commercially available from Ashland LLC.
PVP K12: Polyvinylpyrrolidone, commercially available from Ashland LLC.
Ganex ™ P-904LC: Butylated PVP, commercially available from Ashland LLC.
PVP/VA S-630: a copolymer of vinyl pyrrolidone and vinyl acetate, commercially available from Ashland LLC
Aqualon ™ EC N4: Ethyl cellulose, commercially available from Ashland LLC.

The adhesion test was performed on a heated steel plate. The steel plate was wrapped with a Teflon-coated steel foil. The support filaments were cut into about 1 length segment, then placed on the heated Teflon-coated foil. ABS filaments of 1″ were put on the support filaments in a cross direction. The temperature of the heated plate was increased to about 185° C. A tweezer was used to manually press the ABS filament to the softened support filaments. The filaments were then cooled down to 20-25° C. The adhesion strengths of Samples 1-2 and 4-7 were the same. The filament of Sample 3 had stronger adhesion than the filaments of Samples 1-2 and 4-7. Thus, the support materials having the blend of hydroxypropyl cellulose and vinyl pyrrolidone polymers or the blend of hydroxypropyl cellulose and ethyl cellulose have the same or better adhesion than hydroxypropyl cellulose alone.

### 3D Printing Test

3D printing test was conducted on a Creator Pro dual extrusion 3D printer manufactured by FlashForge Inc. A simple box shape material was printed using the support material of the samples listed in Table 2. The printing quality was assessed by visual inspection of the printed part as well as the easiness of the printing process. The filaments of Samples 2, 3, 4, 5, and 7 listed in Table 2 showed better printing quality than the filaments of Sample 1. Thus, the support materials having the blend of hydroxypropyl cellulose and vinyl pyrrolidone polymers and the blend of hydroxypropyl cellulose and ethyl cellulose have better printing quality than hydroxypropyl cellulose alone.

What is claimed is:

1. A support material for three-dimensional printing comprising: (i) a blend of at least one cellulose ether and at least one vinyl pyrrolidone polymer; or (ii) a blend of at least two cellulose ethers.

2. The support material of claim 1, wherein the cellulose ether is selected from the group consisting of hydroxypropyl cellulose, hydroxypropyl methyl cellulose, hydroxyethyl methyl cellulose, ethyl cellulose, hydroxyethyl cellulose, carboxymethyl hydroxyethyl cellulose and combinations thereof.

3. The support material of claim 2, wherein the cellulose ether is hydroxypropyl cellulose or ethyl cellulose.

4. The support material of claim 3, wherein the cellulose ether is hydroxypropyl cellulose having a weight average molecular weight in the range of from 2,000 to 2,000,000 Daltons.

5. The support material of claim 4, wherein a molar substitution of the hydroxypropyl cellulose is from 2.0 to 5.0.

6. The support material of claim 3, wherein the cellulose ether is ethyl cellulose having ethoxy contents in the range of from 35% to 60%.

7. The support material of claim 1, wherein the vinyl pyrrolidone polymer is selected from the group consisting of a polyvinyl pyrrolidone (PVP), an alkylated polyvinyl pyrrolidone, a vinyl pyrrolidone/vinyl acetate (VP/VA) copolymer, a vinyl pyrrolidone/dimethylaminoethylmethacrylate (VP/DMAEMA) copolymer, a vinyl pyrrolidone/dimethylaminopropylmethacrylamide (VP/DMAPA) copolymer, a vinyl pyrrolidone/methacrylamidopropyl trimethylammonium chloride copolymer, a vinyl pyrrolidone/dimethylaminopropylmethacrylamide/methacrylamidopropyl trimethylammonium chloride terpolymer, a vinyl pyrrolidone/acrylic acid/lauryl methacrylate terpolymer, a vinyl pyrrolidone/acrylic acid copolymer, a vinyl pyrrolidone/vinyl caprolactam copolymer, a vinyl pyrrolidone/vinyl caprolactam/dimethylaminoethylmethacrylate terpolymer, a vinyl pyrrolidone/vinyl caprolactam/dimethylaminopropylmethacrylamide terpolymer, a vinyl pyrrolidone/vinyl caprolactam/dimethylaminopropylmethacrylamide/methacryloylaminopropyl lauryl dimethylammonium chloride tetrapolymer, and a vinyl pyrrolidone/styrene copolymer.

8. The support material of claim 7, wherein a weight average molecular weight of the vinyl pyrrolidone polymer is from about 1,000 to about 3,000.000 Daltons.

9. The support material of claim 1, wherein a ratio of the cellulose ether to the vinyl pyrrolidone polymer is from about 95:5 to about 5:95 by weight.

10. The support material of claim 1, wherein the support material is present in a solid state of powder or granulate.

11. A shaped material comprising the support material of claim 1.

12. The shaped material of claim 11, wherein the shaped material has a shape of a pellet, a rod, or a filament.

13. A three-dimensionally printed object comprising a build material and the support material of claim 1.

14. The three-dimensionally printed object of claim 13, wherein the build material is selected from the group consisting of acrylonitrile butadiene styrene (ABS) copolymers, polylactic acid (PLA), polyamides, polyethylene, polypropylene, polycarbonates, polyoxymethylene (POM), ethylene vinyl acetate copolymers, polyphenylene ether, acrylonitrile styrene acrylate (ASA) copolymers, polyethylene terephthalate (PET), PETG (PET with a glycol modification), high impact polystyrene (HIPS), polyether ether ketone (PEEK), thermoplastic polyurethane, polyetherimide, and combinations thereof.

15. Use of the support material of claim 1 in three-dimensional printing.

16. The use of claim 15, wherein the support material is used for supporting at least one layer of a build material.

17. The use of claim 16, wherein the build material is selected from the group consisting of acrylonitrile butadiene styrene (ABS) copolymers, polylactic acid (PLA), polyamides, polyethylene, polypropylene, polycarbonates, polyoxymethylene (POM), ethylene vinyl acetate copolymers, polyphenylene ether, acrylonitrile styrene acrylate (ASA) copolymers, polyethylene terephthalate (PET), PETG (PET with a glycol modification), high impact polystyrene (HIPS), polyether ether ketone (PEEK), thermoplastic polyurethane, polyetherimide, and combinations thereof.

18. The use of claim 15, wherein the three-dimensional printing comprises a fused deposition modeling.

19. A process for producing a three-dimensional object comprising steps of:
(i) depositing the support material of claim 1 into a build chamber with a layer-based additive technique to form a support structure;
(ii) depositing a build material into the build chamber with the layer-based additive technique to form the three-dimensional object, wherein the three-dimensional object comprises at least one region supported by the support structure; and
(iii) removing the support structure from the three-dimensional object with a liquid medium.

20. The process of claim 19, wherein the build material is selected from the group consisting of acrylonitrile butadiene styrene (ABS) copolymers, polylactic acid (PLA), polyamides, polyethylene, polypropylene, polycarbonates, polyoxymethylene (POM), ethylene vinyl acetate copolymers, polyphenylene ether, acrylonitrile styrene acrylate (ASA) copolymers, polyethylene terephthalate (PET), PETG (PET with a glycol modification), high impact polystyrene (HIPS), polyether ether ketone (PEEK), thermoplastic polyurethane, polyetherimide, and combinations thereof.

21. The process of claim 19, wherein the liquid medium comprises water, an aqueous solution and a solvent.

22. The process of claim 21, the liquid medium is the aqueous solution having a pH of about 5.0 to about 9.0.
